(19) United States
(12) Patent Application Publication
(10) Pub. No.: US 2007/0252382 A1
(43) Pub. Date: Nov. 1, 2007

(54) Laminated multi-ply in-mold label

(76) Inventors: Robert E. Baum, Dell Rapids, SD (US); Donald P. Klein, Dell Rapids, SD (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/384,578

(22) Filed: Mar. 20, 2006

(51) Int. Cl. B42D 15/00

(52) U.S. Cl. 283/107

(57) ABSTRACT

A laminated, two-ply, in-mold label having a top ply laminated to a base ply. Printing is included between the plies and optionally on the upper surface of the top ply. The printing between the plies is physically protected in the applied label.

### BACKGROUND OF THE INVENTION

The present invention relates to labels and labeling, and more particularly to in-mold labels and labeling.

In-mold labels and labeling are well known. Such labels are adhered to an article, such as a bottle, during the molding of the article. The label is placed within the cavity of a mold before molding, and the label adheres to the surface of the article during molding.

A typical application is in the production of blow-molded containers. A preprinted label with heat activated adhesive is placed against the surface of the mold cavity and held by vacuum ports in the mold. The mold is closed, and the plastic blank is heated and inflated within the mold. The hot plastic presses against the label, activating the adhesive and causing the label to adhere to the outer surface of the newly molded container. The mold is opened and the labeled container is ejected from the mold. In-mold labels may be furnished as a stack of precut discrete labels or as a continuous web of adjacent labels joined edge to edge and subsequently cut and applied. In-mold labels are disclosed in U.S. Pat. No. 5,344,305 to McKillip.

In-mold labels (IMLs) offer a wide variety of printing, graphics, and other treatments. Unfortunately, some inks are not practical choices for inclusion in IMLs. For example, metallic inks are easily scratched or marked if they are on the face of the label; and metallic inks can interfere with application of the label to the bottle if they on the reverse side of the label.

### SUMMARY OF THE INVENTION

The aforementioned problems are overcome by the present invention comprising a laminated, multi-ply, in-mold label (IML) having printing between two plies. In the current embodiment, the label includes a base layer and a second layer. The base layer includes a heat activated adhesive on its bottom surface. The second layer is laminated to the base layer. Printing is included on either of the facing surfaces of the two plies (i.e. between the two plies). The invention is extendable beyond the current embodiment to labels having three or more plies.

The present invention facilitates use of specialty inks including, but not limited to, highly reflective and/or metallic inks. The laminated multi-ply IML enables a wide variety of decorative, sleek, and otherwise aesthetically pleasing labels.

These and other objects, advantages, and features of the invention will be more fully understood and appreciated by reference to the description of the current embodiment and the drawings.

### BRIEF DESCRIPTION OF THE DRAWINGS

FIG. 1 is a perspective view of the laminated, two-ply, in-mold label on a bottle.

FIG. 2 is a perspective, sectional view of the label.

### DESCRIPTION OF THE CURRENT EMBODIMENT

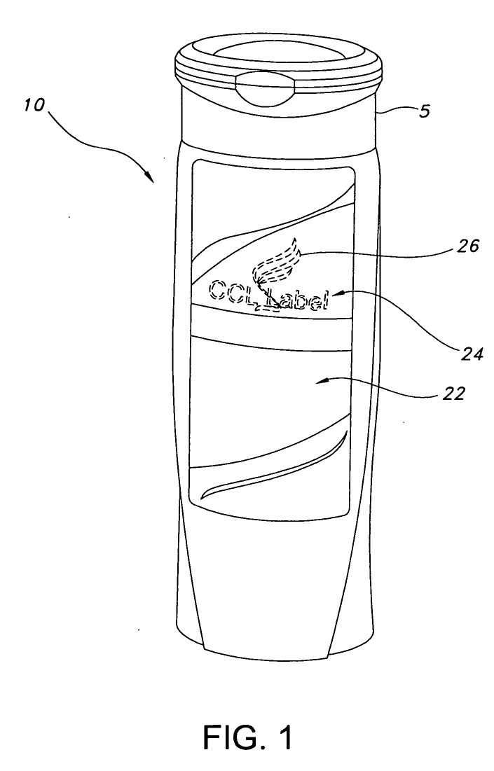

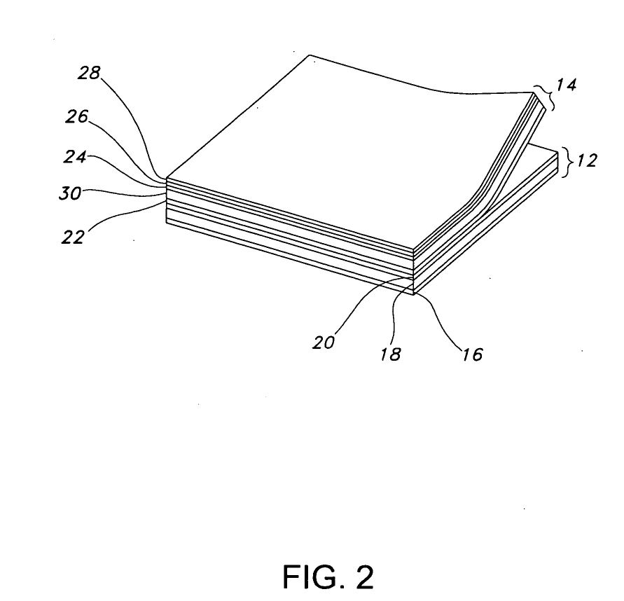

One embodiment of the in-mold label (IML) of the present invention is illustrated in FIGS. 1-2, and generally designated 10. The label 10 is applied to an article 5 and includes a base ply 12 and a top ply 14. Printing 22, 24, and 26 is located between the two plies and also on the upper surface of the top ply 14.

I. In-Mold Label

The described embodiments contemplate a laminated two-ply IML, and each of the two plies are described in detail, however, the laminated IML may contain additional or different plies. For example, a person of skill in the art would understand how to extend the described embodiment to product an IML having three or more plies.

A. Base Ply

The base ply 12 generally includes a base layer 18, an adhesive 16 on the lower surface of the base layer 18, and an adhesive 20 on the upper surface of the base layer 18. The illustrated base layer 18 is a rectangular piece of plastic film. Alternatively, the base layer 18 may be constructed of any other suitable material known to those skilled in the art.

The adhesive layer 16 may be applied to the lower surface of the base layer 18 in a variety of manners and patterns, as will be appreciated by those skilled in the art. In the current embodiment, the adhesive in the layer 16 is responsive to or activated by heat. Alternatively, the adhesive layer 16 may be made from other suitable adhesives capable of being activated during the molding process.

The adhesive layer 20 may be applied to the upper surface of the base layer 18 in a variety of manners and patterns, as will be appreciated by those skilled in the art. In one embodiment, the adhesive layer 20 is laminating adhesive such as solvent gravure, moisture cured, 100% solids gravure, and/or UV-cured laminating adhesives. Alternatively, the adhesive layer 20 may be other suitable laminating adhesives.

B. Top Ply

The laminating or top ply 14 generally includes layer 30 and a printing layer 22 applied to the lower surface of the layer 30. Optionally, the top ply 14 includes ink layers or printing 24, 26 applied to the upper surface of the layer 30 and one or more protective coatings 28 on the upper surface of the material 30. The top ply 14 may include additional, fewer, or differently configured layers.

The material 30 is a plastic film similar in shape and size to the base ply 12. Alternatively, the material 30 may be shaped differently and constructed of other suitable material. In the current embodiment, the film 30 is clear or transparent. White or other printing may be used to alter the opacity and hide printing on the lower surface of the top ply 14. The film 30 alternatively may be translucent depending on the desired appearance.

The top laminating ply 14 overlays the base ply 12 uniformly and closely to avoid the entrapment of any substantial amount of air between the two plies 12, 14.

Although the adhesive layer 20 in the described embodiment is associated with the base ply, in alternative embodiments the adhesive layer 20 may be part of the top ply 14.

In the illustrated embodiment, the top ply 14 includes pattern ink or printing 22, 24, 26. The printings 24, 26 may be included on the upper surface of the material 30 and/or as separate layers between the material 30 and the coating 30. The printing 22 may be included on the lower surface of the material 30. In top ply adhesive embodiments, the printing 22 may be included on the adhesive 20, and/or as a separate layer between the material 30 and the adhesive 20.

The content of the printings 22, 24, 26 of the top ply 14 may vary. The printings 22, 24, 26 may include graphical and/or textual information. In the illustrated embodiment, printing layer 22 includes a decorative background, printing layer 24 includes identifying textual information about the article 5, and printing layer 26 includes decorative graphics. The printing layers 22, 24, 26 may be constructed and applied using any suitable technique known to those skilled in the art. For example, in the illustrated embodiment, the printing layer 22 is printed using gravure silver, and the printing layers 24, 26 are printed using UV flex and/or UV screen. Other suitable printing inks are and/or will be know to those skilled in the art.

The inks used in printing the facing surfaces of the plies (i.e. between the plies) are physically protected in the final label. Consequently, a wide variety of inks can be used in this are for desired visual effects that might not be suitable for use on an exposed layer. Such inks include metallic inks, which can be easily scratched and/or which can interfere with adhesion of the label to the bottle.

One or more coatings 30 may cover the upper surface of the film 30 to protect the top ply 14 and/or the printings 24, 26 from damage. The coating may be constructed of any suitable material known to those skilled in the art.

II. Application and Use of the IML

In operation, preprinted and adhesive-coated labels 10 are provided in roll, magazine, or other suitable forms (not shown) as known in the art. The labels 10 may be transferred to the interior of a blow or injection mold (not shown) using techniques and apparatuses known in the art. Once transferred, known molding techniques may be used to form the container and thereby adhere the IML 10 to the molded article 5. For example, a two-ply IML may be placed in a mold with the adhesive 16 facing away from the mold. The adhesive 16 is activated by the molding process causing the label 10 to be adhered to the article 5. Once the molding is finished, the molded article 5 with the adhered two-ply label 10 may be removed from the mold (not shown). In the current embodiment, the IML 10 becomes part of the molded article 5 during the molding process.

In use, the IML 10 includes printing between the top ply and the base ply and optionally includes additional printing on the upper surface of the top ply. FIG. 1 depicts an article 5 with a two-ply IML 10. The inks between the plies are fully physically protected in the applied IML.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A in-mold label comprising:
a base ply having upper and lower surfaces, said base ply lower surface including an adhesive;
a top ply having upper and lower surfaces, said lower surface of said top ply facing said upper surface of said base ply, at least one of said top ply lower surface and said base ply upper surface including printing, said top ply laminated to said base ply, whereby said printing is protected therebetween.

2. The in-mold label of claim 1 further comprising second printing on said top ply upper surface.

3. The in-mold label of claim 1 where said printing includes metallic ink.

4. The in-mold label of claim 1 wherein said adhesive includes an in-mold process activated adhesive.

5. An in-mold label comprising:
a first ply having an upper surface and a lower surface;
a second ply laminated to first ply;
printing on at least one of said first and second plies between said first and second plies.

6. The in-mold label of claim 5 further comprising adhesive means for adhering said label to an object during a molding process.

7. The in-mold label of claim 5 wherein said adhesive means includes an in-mold process activated adhesive.

8. A method for molding an article having a multi-ply label comprising the steps of:
placing a multi-ply label in a mold, the label including at least two plies and printing between the two plies;
molding the article in the mold causing the multi-ply label to adhere to the article; and
removing the molded article with the adhered multi-ply label from the mold.

9. The method of claim 8 wherein said placing step comprises including an adhesive on the label facing away from the mold to improve adhesion between said label and said article.

10. The method of claim 8 wherein said molding step comprises blow molding.

11. The method of claim 8 wherein said molding step comprises injection molding.
